(19) United States
(12) Patent Application Publication
(10) Pub. No.: US 2005/0043991 A1
(43) Pub. Date: Feb. 24, 2005

(54) Consumer printable coupon fundraising process

(76) Inventor: Daniel Mark Abraham, Kenner, LA (US)

Correspondence Address: DANIEL MARK ABRAHAM, 308 Pellerin Dr., Kenner, LA, 70065, US

(21) Appl. No.: 10/642,902

(22) Filed: Aug. 19, 2003

(51) Int. Cl. G06F 17/60

(52) U.S. Cl. 705/14

(57) ABSTRACT

An electronic Process/approach utilizing proprietary Internet Websites as Portals to distribute and disseminate information/brand coupons and/or promotions, for the purposes of generating funds for the Causes (not-for-profits, charitable organizations and/or schools). Brands remunerate the inventor on a performance basis, for providing a distribution source for their consumer-printable coupons online and moving product. This coupon content in turn, would provide a revenue share to the Cause, in light of their promotion of the Portal. This approach provides a unique method for fundraisers for the Causes; a most effective and more public-sensitive promotion for the Brands; and a benefit to the Supporters as well, in that they are able to obtain free brand coupons on the various Portals of the Process and support the Causes, all at the same time. The Process promises to be a tremendous consumer relationships marketing tool as well. Brands are attempting to establish consumer loyalty. Participating in the Process and supporting the Cause too can generate this. In doing so the consumer/Supporter develops a loyalty or affinity to the sponsoring brand. A unique consumer relationship is established to the benefit of the Cause and the Brand as well.

### REFERENCES CITED

U.S. Pat. Documents

| | | | |
|---|---|---|---|
| 507693 | Jun. 2, 1998 | Gordon | 705/14 |
| 600751 | May 25, 1999 | Engel | 705/14 |
| | Dec. 29, 19988 | Jovicic | 705/14 |
| | Jun., 1998 | Toader | 705/14 |
| 651596 | Dec. 14, 1999 | Nielson | 705/14 |
| | Dec. 29, 1998 | Jovicic | 705/14 |
| | Jun., 1998 | Toader | 705/14 |

Other References

Safeway Coupon and Letter Publication, published prior to May 9, 1991.
Shulman; “Electronic marketing: a big-stakes game for the retailer and the
manufacture”; Super market Business, vol. 43, No. 2, pp. 21-22, Feb.
1988.
CMT (Critical Mass Targeted) literature, “Select & Save Database Co-Op
Coupon Program”, publication date unknown.
Teitelbaum, Richard S., “Companies to Watch--Catalina Marketing,”
Fortune, vol. 125, No. 10, May 18, 1992.
Sloane, Martin, “Electronic Coupon Idea Shows Vision,” The Herald-
Palladium, Benton Harbor, Michigan, Jul. 6, 1992.
“A trio of model fundraising approaches”-Dana Farber Cancer Institute
Internet 2003
http://www.accc-cancer.org/publications/journaljuly01/fundraisingtrio.asp
“Exploring Online Fundraising for Non profit Arts Organizations.”-
Internet 2003 http://www.idealist.org/beth.html
“The Non Profits Guide”-Internet
http://www.npguides.org/guide/links.htm
“The Basics in Developing Your Fund raising Program”-Internet 2003
http://www.managementhelp.org/np_progs/fnd_mod/fnd_raise.htm

### FIELD OF THE INVENTION

### BACKGROUND OF THE INVENTION

With the variety of coupon and rebate sites popping up on the Internet, the Web promises to be the brand-marketing vehicle of the future. But no invention has yet touched on the unique Process of utilizing online coupons as fundraising tools.

The Internet provides a terrific promotion resource with its speed and distribution ability but manufacturers have major issues with Web-based, printable incentive offers but are looking for alternatives to conventional print coupons.

Causes like not-for-profits, charitable organizations and schools are always looking for fundraising tools and methods to help generate additional revenue.

This Process/invention addresses the above factors and utilizes the Internet and brand coupons to present a unique fund raising vehicle.

### SUMMARY OF THE INVENTION/PROCESS

An Internet Portal (Website) is provided to distribute online consumer-printable coupons. As the coupons are redeemed at point of purchase and subsequently processed by an independent 3^{rd} party redemption company or agent, revenue is generated from the participating brands, paying for the promotion.

The invention/Process provides specific online portals designated to work with the Causes (not-for-profits, schools or charitable organizations). Supporters of these Causes, visiting these Portals, printing and redeeming the provided coupons, generate revenue for the respective Cause.

This revenue share used as a fund raising tool is the heart of the Process. Its innovation is unique.

Full tracking and accounting is provided to the brands and the Cause, by the proprietary database working in conjunction with the Process.

The amount of funds generated by the Process is directly related to the proactivity of the participating Cause, based on redemption re-imbursement paid by the brand.

This invention/Process capitalizes on the value of coupons and its expansive online market to provide a unique Process for generating revenue for fundraisers or other not-for-profits, while increasing the sales of the brands.

Brand loyalty is another consideration of the Process. And brand loyalty is a critical pursuit of brands. The Process helps build brand loyalty while loyalty is also being built with the organization, school or charity. Supporters come to the portal sites to obtain FREE brand coupons and to support the Cause. From the coupon value that is obtained, and the savings, which is derived from the usage, consumer loyalty is established.

This Process is a unique and innovative approach to consumer loyalty building for brands. This Process truly provides benefit to every constituent:
The Cause gets additional revenue at no cost other than an agreement to promote the Process.
The Supporter saves money on purchases, using the free coupons provided by the Process.
Participating brands receive the perks of sponsorship, develop a more loyal consumptive group of consumers and move product more cost effectively.
   Everyone Wins!

It is the object of this invention/Process to provide an online approach to distribute brand coupons for the purposes of generating funds for to the benefit of a variety of Causes. The Process integrates online brand coupon promotion, a Cause's ongoing need for funds, and the Supporters desire to obtain free brand coupons so as to save on brand products.

The Process provides for al 3 of constituents.

### BRIEF DESCRIPTION OF DRAWINGS

Drawing 1 illustrates the online approach of the Process including The Portal, the sponsor, the Cause and the Supporter.

Drawing 2 illustrates the approach to tracking and identifying all redeemed coupons to provide accurate accounting and tracking of the redemptions.

### DETAILED DESCRIPTION OF PREFERRED EMBODIMENTS

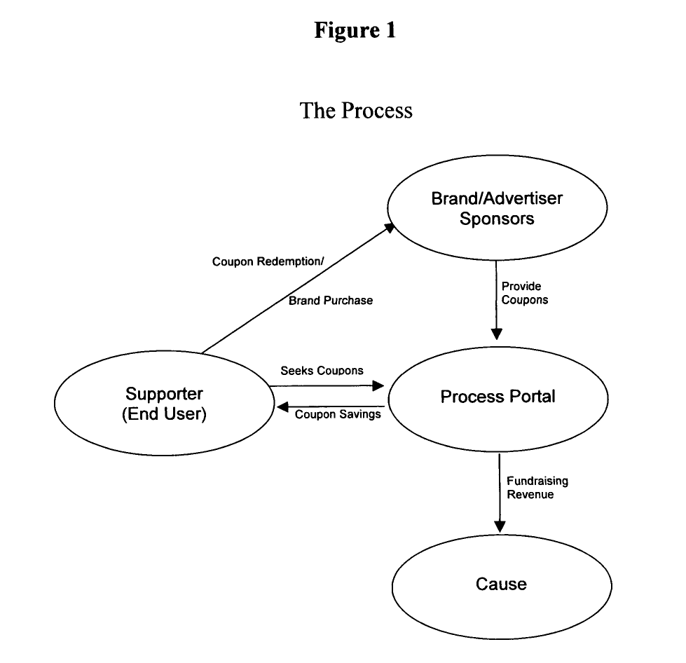

FIG. 1 generally illustrates the Process and its constituents. The Supporter visits The Portal to obtain coupons and support the Cause. The Portal maintains coupon offers provided by the Sponsor (the Brand).

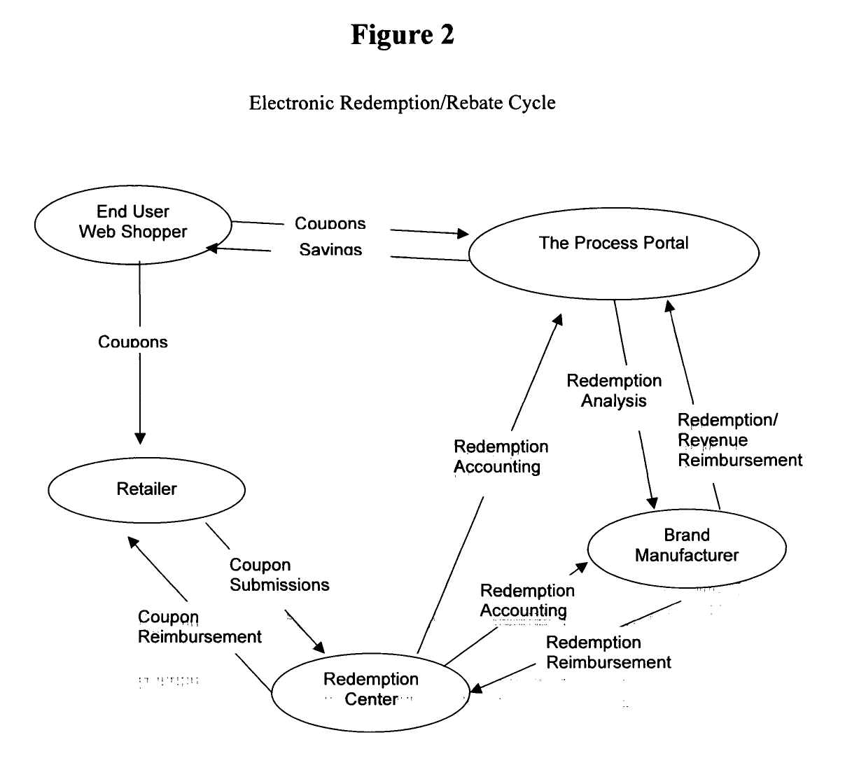

In practicality, duplicates can be provided at the point of purchase on the retail level, which may not be redeemed by the Store (the Brands or the Advertisers). These are fraudulent redemptions and are detailed in FIG. 2.

FIG. 2 generally illustrates the consideration of the redemption Process in its generation of income and impact on the Process. The Process primarily addresses consumer package goods incentive offers.

In reality, the end user then takes the printed coupon offers to a Retailer. Once purchases of promoted products are made, and the incentive is presented for redemption at point of sale, the Retailer accepts these Supporter printed coupons, which have been presented at point of sale and are redeemed.

The Retailer then submits the offers to their redemption agent or directly to a redemption facility to be reimbursed. The redemption facility scans the offers into its data Processing system.

The proprietary software of the Process, identifies and validates the coupon utilizing its indigenous household identification number contained in its bar code. An accounting of all transactions is maintained for and accessible to Stores (the Brands or Advertisers) for verification and proper redemption, through this code. This is the code used to track all revenue owed the Cause as a result of Supporter redemption.

The present invention also provides a unique electronic Process to marketing products online while using these same products to become fund raising tools for Causes based on a pay for performance model.

1. An electronic Process by which consumer-printable coupons/promotions are provided online through a specific Portal or Website, and the redemption of these coupons generates a revenue share, to be shared with the participating Causes—not-for-profits, charities or schools.
I claim that through this Process the specific Causes are identified through by the Household ID number printed on every coupon, through the use of the UCC/EAN extended 128 barcode.
The Supporter selects the Cause he/she would like to support with their coupon redemption.
I claim that each coupon offer displayed in the Process contains indigenous Bar codes and information like the following:
The Store or Brand name; the item name; the value of the incentive;
disclaimers and modifiers for the incentive; the origin of the incentive by zip code; graphics or product images.
The incentives displayed in the Process are viewed and selected by endusers (Supporters).
The incentives are free to the Supporter;
Are available twenty-four hours a day, seven days a week;
Viewable and printable by the end user, at their discretion;
Are printed on the Supporter's printer.
I further claim that each printed incentive is identified and maintained in the proprietary database, in this Process, by UCC/EAN Bar codes; an indigenous identification number or tracking code, which is logged into the Process's database for tracking purposes.
The Storefront's database maintains all necessary information and reporting regarding all departments, incentives or remuneration, links, Supporter accounts and redemption information on the coupons.

2. Proprietary databases are used by the Process to identify the supporter, the Cause and the brand.
I claim that upon the offers, once promoted on the Portal by the Process and its inventor,
Are selected by supporters who redeem them at the grocery stores.
Once they are redeemed, the grocery submits them to independent third parties, who idendify them and process them for the brands.
Duplicate redemption files are generated by the third party redeemer, with copies going to the brand and to the Process inventor as well.
Redemption activity is identified with respect to the Supporter and the Cause with respect to each brand redemption.
I claim that the Process provides this track ability, allowing for the revenue share of the redemption amount.
